(19) United States
(12) Patent Application Publication
(10) Pub. No.: US 2004/0163434 A1
(43) Pub. Date: Aug. 26, 2004

(54) Fertiliser compositions

(76) Inventor: Bertram Francis Charles Quin, Auckland (NZ)

Correspondence Address: JACOBSON HOLMAN, 400 SEVENTH STREET, N.W., WASHINGTON, DC, 20004, US

(21) Appl. No.: 10/725,040

(22) Filed: Dec. 2, 2003

Related U.S. Application Data
(63) Continuation of application No. PCT/NZ02/00077, filed on Apr. 26, 2002.

(30) Foreign Application Priority Data
May 9, 2001 (NZ) 511606

(51) Int. Cl. C05C 9/00

(52) U.S. Cl. 71/28

(57) ABSTRACT

A fertiliser composition in the form of granules or prills where urea has been coated with wet ground sulphur. The wet ground sulphur is preferably applied serially and/or simultaneously with one or both of a nitrification inhibitor and a urease inhibitor.

In its preferred form there is a core of urea and an inner peripheral zone of both at least urea and sulphur. The outer peripheral zone can be of at least urea and sulphur or at least sulphur, or both.

### TECHNICAL FIELD

The present invention relates to fertilisers.

Urea is a frequently used fertiliser as a source of ground and/or plant nitrogen.

Sulphur-coated urea products have been developed and are considered to be useful because

1) urea being a high nitrogen containing product, even when coated, still results in a product having a nitrogen content of about 38 to 44% by weight;

2) sulphur coating of urea reduces leaching of nitrate and volatilisation of nitrous oxide and ammonia;

3) sulphur coating of urea therefore improves the efficiency of utilisation of the nitrogen in the urea;

4) sulphur is relatively cheap; and

5) sulphur is itself a valuable secondary nutrient.

6) such products can be blended with phosphate fertilisers.

Some sulphur coating procedures rely on the addition of additional agents in order to achieve an effective coating whilst others rely upon a melt application procedure. Dry coating procedures have a disadvantage in that the coating, even prior to application as a fertiliser, can become cracked, in which case it breaks off the urea and the coating benefits are lost.

### SUMMARY OF THE INVENTION

The present invention recognises the prospect of a simple procedure being utilised to provide an effective coating of urea using sulphur and which additionally has the advantage of being capable of being used in conjunction with the incorporation of nitrification inhibitors and/or urease inhibitors, if required or desired. It is to this therefore that the present invention is directed.

In a first aspect the present invention consists in a particulate fertiliser composition of particulate urea (eg; granules or prills) coated with wetground sulphur. Preferably said wet ground sulphur has been dewatered to some extent (ie; 5 to 20% and most typically to 8-15% by weight moisture) prior to the association of such sulphur particles with the urea particles.

Preferably said sulphur particles serially or simultaneously are associated with said urea with a nitrification inhibitor and/or a urease inhibitor.

In another aspect the present invention consists in a particulate fertiliser composition of particulate urea coated with both sulphur and a nitrification and/or urease inhibitor.

Preferably said sulphur is wet ground sulphur.

Preferably at least 90% of the said sulphur is of particle size from 10 to 150 microns (preferably of a medium particle size of about 75 microns).

Preferably said urea is in the form of (standard or other) granules or prills and each such particle (ie; granule or prill) has a weight of sulphur plus moisture plus inhibitor added (expressed as a % of the total weight of prill or granule) in the range of from 5 to 25% (more preferably 5 to 20%). Alternatively 10 to 25%.

Preferably said nitrification inhibitor is selected from the group consisting of DCD (dicyandiamide) or DIDIN™ (a DCD containing product of SKW, Germany which also includes ammonium thiosulphate and ammonium phosphate).

Preferably the nitrification inhibitor is incorporated as a fine particle or as a solution.

Preferably the weight percentage of nitrification inhibitor relative to sulphur is in the range of from 5% to 50% by weight (alternatively 10 to 50%)

Preferably the urease inhibitor is AGROTAIN™ Urease Inhibitor, a liquid product (of N-(n-butyl)thiophosphoric triamide in N-methyl pyrrolidone and another solvent) produced by Agrotain International LLC, Indiana, USA.

Preferably the weight percentage of urease inhibitor relative to sulphur is in the range of 2 to 12%.

Preferably the weight percentage of sulphur relative to urea is from 4% to 15% (alternatively 5 to 15% or 10 to 15%).

Preferably said sulphur at the time of its association with the urea has a water content of from 8% to 15%.

Preferably the coating of the urea is with a mixture of the sulphur and the nitrification and/or urease inhibitor.

Preferably said product has been formed by combining sulphur (that has been ground underwater and subsequently de-watered) with the nitrification inhibitor and the subsequent mixing of that mixture with the urea.

In still a further aspect the present invention consists in a urea based fertiliser being or having urea granules coated to provide a surrounding matrix of both sulphur and a nitrification inhibitor, the sulphur binding into the urea to create a mixed urea/sulphur transition zone which may (and preferably does) include some of said nitrification and/or urease inhibitor.

In still a further aspect the present invention consists in a fertiliser in granule, prill or the like form having a core of urea, an inner peripheral zone of both at least urea and sulphur and an outer peripheral zone of both at least urea and sulphur and an outer peripheral of at least sulphur.

Preferably one or both of said peripheral zones includes a nitrification and/or urease inhibitor.

In still a further aspect the present invention consists in a method of preparing a fertiliser from particulate urea (eg; granules or prills) which comprises or includes mixing such particulate urea (serially and/or simultaneously) with a wetground elementary sulphur and a compatible nitrification and/or urease inhibitor.

Preferably said mixing is simultaneous, ie; the wet ground and de-watered sulphur having previously been mixed with the preferably particulate nitrification and/or urease inhibitor.

Preferably the characteristics of the nitrification and/or urease inhibitor, the sulphur and the urea and their relativities are substantially as previously stated.

In still a further aspect the present invention consists in a urea granule or prill based fertiliser having a surround which includes both elementary sulphur and a nitrification and/or urease inhibitor, the sulphur binding or assisting in the binding of the nitrification and/or urease inhibitor to the area.

Preferably said sulphur was wet ground sulphur.

In still a further aspect the present invention consists in the fertiliser usage of a fertiliser composition or urea based fertiliser product as previously stated, ie; by its application to a locus of the ground to be fertilised.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred forms of the present invention will now be described with reference to the accompanying drawings in which;

FIG. 1 shows typical breakdown chemical reactions of urea which generates both N₂O and ammonia in addition to forms of nitrogen which can be utilised by plants, and

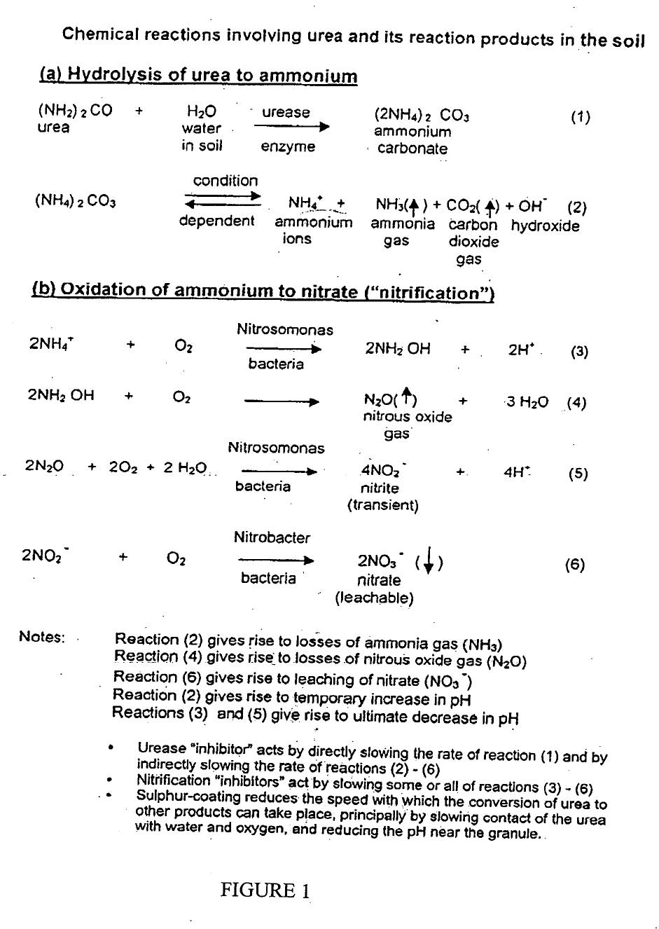

FIG. 2 shows a flow diagram of a preferred process in accordance with the present invention, etc.

### DETAILED DESCRIPTION OF THE INVENTION

As used herein the term “wet grinding” in relation to sulphur involves any physical modification of the sulphur by physical or mechanical means in a liquid environment and preferably water with a view to size reduction.

Details of one such procedure developed by M W Brown of New Zealand Pastoral Agriculture Research Institute Limited (possibly subsequently assigned to HiTech Products Limited and subject to their NZ Patent Application 337251) was disclosed in the Agritech 2000 TV Programme 18 recorded 5 Sep. 1997 and broadcast in New Zealand.

The aforementioned TV Agritech 2000 TV Programme 18 makes reference to a milkshake type dispersing apparatus to reduce the size of the sulphur in water. They attributed to that crude disperser process the prospect of size reduction dependent on water to sulphur ratio, dependent on duration of disperser use and dependent on speed of the disperser in to the there depicted accumulations of 0.25 mm, 0.15 mm, 0.075 mm and less than 0.075 mm wet ground sulphur.

A suitable disperser for such purpose could be that as used in that programme or that subsequently used by HiTech Products Limited. Other suitable dispersers for such a process are those of IKA and Silverson.

It is to the production of such size reduced sulphur with its consequential characteristics that the term “wet grinding” (or variations of the term) relates even if it is not what would be considered as grinding or milling if in a dry environment.

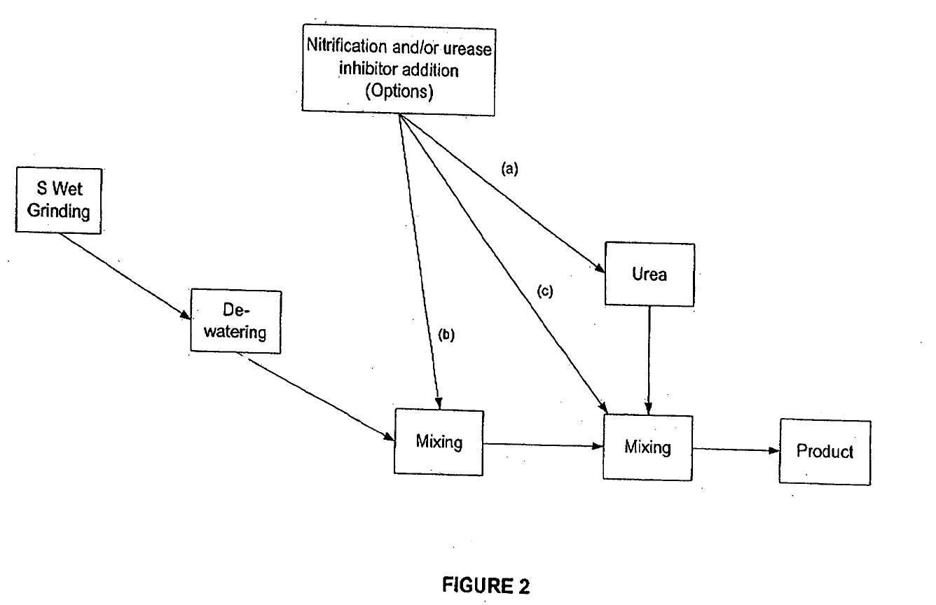

The de-watering step referred to in FIG. 2 is preferably no more than a physical de-watering procedure such as might occur by pouring the sulphur slurry into porous bags and applying pressure to force excess water out and thereafter conditioning the resultant moist sulphur solids to break up soft lumps of sulphur.

The mixing procedure can be in any suitable blending apparatus for the initial introduction of the nitrification and/or urease inhibitor. Likewise the same or a different mixing or blending apparatus can be used for blending the urea into (as preferred) the preexistent mix of the wetground sulphur and the nitrification and/or urease inhibitor.

The resultant product, which is a pale yellow in appearance, otherwise has much the same physical appearance of uncoated urea granules or prills and has similar free flow characteristics without any ready tendency to shed the coating.

Where the main requirement for sulphur is as a nutrient in its own right, and to help reduce ammonia volatilisation through reducing the pH around the granules, sulphur addition is more likely to be in the 4 to 10% weight range relative to the urea.

Where the main requirement for sulphur is to make a urea coated product that can be blended with soluble phosphate fertilisers, sulphur addition is more likely to be in the 10-15% weight range relative to the urea.

1. A particulate fertiliser composition of particulate urea coated with wet ground sulphur.

2. A composition of claim 1 in the form of granules or prills.

3. A composition of claim 1 wherein said wet ground sulphur has been dewatered to some extent prior to the association of such sulphur with the urea.

4. A composition of claim 3 wherein said dewatering has been to 8 to 15% moisture.

5. A composition of claim 3 wherein said dewatering has been to 5 to 20% moisture.

6. A composition of claim 1 wherein said sulphur has been associated with said urea serially (before or after) or simultaneously with a nitrification inhibitor.

7. A composition of claim 1 wherein said sulphur has been associated with said urea serially (before or after) and/or simultaneously with a urease inhibitor.

8. A particulate fertiliser composition of particulate urea coated with both sulphur and a nitrification inhibitor.

9. A particulate fertiliser composition of particulate urea coated with both sulphur and a urease inhibitor.

10. A composition of claim 8 wherein said sulphur is wet ground sulphur.

11. A composition of claim 10 wherein at least 90% of the said sulphur is of particle size from 10 to 150 microns of a median particle size of about 75 microns.

12. A composition of claim 1 wherein said urea is in the form of granules or prills and each such granule or prill has a weight of wet ground sulphur plus moisture plus inhibitor added (expressed as a % of the total weight of prill or granule) in the range of from 5 to 20%.

13. A composition of claim 12 wherein each such granule or prill has a weight of sulphur plus moisture plus inhibitor added (expressed as a % of the total weight of prill or granule) in the range of from 10 to 20%.

14. A composition of claim 10 wherein the sulphur at the time of the coating had a moisture content of from 8 to 15% by weight.

15. A composition of claim 8 wherein the nitrification inhibitor is incorporated as fine particles or as a solution.

16. A composition of claim 15 wherein the weight percentage of nitrification inhibitor relative to sulphur is in the range of from 5% to 50%.

17. A composition of claim 16 wherein the weight percentage of nitrification inhibitor relative to sulphur is in the range of from 10% to 50%.

18. A composition of claim 9 wherein the weight percentage of urease inhibitor relative to sulphur is in the range of 1 to 12%.

19. A composition of claim 1 wherein the weight percentage of sulphur relative to urea is from 4% to 15%.

20. A composition of claim 19 wherein the weight percentage of sulphur relative to urea is from 8% to 15%.

21. A composition of claim 19 wherein the weight percentage of sulphur relative to urea is from 4% to 10%.

22. A composition of claim 19 wherein the weight percentage of sulphur relative to urea is from 10% to 15%.

23. A composition of claim 19 wherein said sulphur at the time of its association with the urea has a water content of from 8% to 15%.

24. A composition of claim 8 wherein the coating of the urea is with a mixture of the sulphur and the nitrification inhibitor.

25. A composition of claim 9 wherein the coating of the urea is with a mixture of the sulphur and the urease inhibitor.

26. A composition of claim 8 wherein the coating of the urea is with a mixture of the sulphur and both a nitrification inhibitor and an urease inhibitor.

27. A composition of claim 24 wherein said product has been formed by combining sulphur (that has been ground underwater and subsequently de-watered) with the nitrification inhibitor and the subsequent mixing of that mixture with the urea.

28. A composition of claim 25 wherein said product has been formed by combining sulphur (that has been ground underwater and subsequently de-watered) with the crease inhibitor and the subsequent mixing of that mixture with the urea.

29. A urea based fertiliser being or having urea granules coated to provide a surrounding matrix of both sulphur and a nitrification inhibitor, the sulphur binding into the urea to create a mixed urea/sulphur transition zone which may include some of said nitrification inhibitor.

30. A urea based fertiliser being or having urea granules coated to provide a surrounding matrix of both sulphur and a urease inhibitor, the sulphur binding into the urea to create a mixed urea/sulphur transition zone which may include some of said urease inhibitor.

31. A urea based fertiliser being or having urea granules coated to provide a surrounding matrix of sulphur, a urease inhibitor and a nitrification inhibitor, the sulphur binding into the urea to create a mixed urea/sulphur transition zone which may include some of one or both of said nitrification and urease inhibitors.

32. A fertiliser in granule, prill or the like form having a core of urea, an inner peripheral zone of both at least urea and sulphur and an outer peripheral zone of both at least urea and sulphur and an outer peripheral zone of at least sulphur.

33. A fertiliser of claim 32 wherein one or both of said peripheral zones includes a nitrification inhibitor.

34. A fertiliser of claim 32 wherein one or both of said peripheral zones includes a urease inhibitor.

35. A fertiliser of claim 32 wherein one or both of said peripheral zones includes both a nitrification and urease inhibitor.

36. A method of preparing a fertiliser from particulate urea which comprises or includes mixing such particulate urea (serially and/or simultaneously) with a wetground elementary sulphur and a compatible nitrification inhibitor.

37. A method of preparing a fertiliser from particulate urea which comprises or includes mixing such particulate urea (serially and/or simultaneously) with a wetground elementary sulphur and a compatible nitrification and urease inhibitor.

38. A method of preparing a fertiliser from particulate urea which comprises or includes mixing such particulate urea (serially and/or simultaneously) with a wetground elementary sulphur and a compatible nitrification and urease inhibitor.

39. A method of claim 36 wherein said mixing is simultaneous, ie; the wet ground and de-watered sulphur having previously been mixed with the preferably particulate nitrification and/or urease inhibitor.

40. A urea granule or prill based fertiliser having a surround which includes both elementary sulphur and a nitrification inhibitor, the sulphur binding or assisting in the binding of the nitrification inhibitor to the urea.

41. A urea granule or prill based fertiliser having a surround which includes both elementary sulphur and a urease inhibitor, the sulphur binding or assisting in the binding of the urease inhibitor to the urea.

42. A urea granule or prill based fertiliser having a surround which includes both elementary sulphur and a urease inhibitor, the sulphur binding or assisting in the binding of the urease inhibitor to the urea.

43. A urea granule or prill based fertiliser as claimed in claim 40 wherein said sulphur was wet ground sulphur.

44. The fertiliser usage of a fertiliser composition or fertiliser of claim 1.
